(19) United States
(12) Patent Application Publication
(10) Pub. No.: US 2017/0155097 A1
(43) Pub. Date: Jun. 1, 2017

(54) SECONDARY BATTERY

(71) Applicant: SAMSUNG SDI CO., LTD., Yongin-si (KR)

(72) Inventors: Seon Yeong KANG, Yongin-si (KR); Jang Ho YOON, Yongin-si (KR)

(21) Appl. No.: 15/363,316

(22) Filed: Nov. 29, 2016

(30) Foreign Application Priority Data
Nov. 30, 2015 (KR) 10-2015-0169275

(51) Int. Cl. H01M 2/02; H01M 2/26; H01M 2/08

(52) U.S. Cl. CPC H01M 2/028; H01M 2/08; H01M 2/26; H01M 2220/20

(57) ABSTRACT

A secondary battery includes an electrode assembly including an electrode tab with a buffer, a case to accommodate the electrode assembly, and an insulator between the electrode assembly and the case.

### CROSS-REFERENCE TO RELATED APPLICATION

Korean Patent Application No. 10-2015-0169275, filed on Nov. 30, 2015, and entitled: “Secondary Battery,” is incorporated by reference herein in its entirety.

### BACKGROUND

1. Field

One or more embodiments described herein relate to a secondary battery.

2. Description of the Related Art

The demand for secondary batteries is increasing. Recently, research has been conducted into secondary batteries for powering electric and hybrid automobiles. The electrode assemblies and projecting conductive members of secondary batteries are subject to damage.

### SUMMARY

In accordance with one or more embodiments, a secondary battery which includes an electrode assembly including an electrode tab with a buffer; a case to accommodate the electrode assembly; and an insulator between the electrode assembly and the case. The insulator may be attached to an outer peripheral surface of the electrode assembly. The insulator may be attached to a surface of the electrode assembly and a surface of the case, and the surfaces of the electrode assembly and the case may face each other.

The insulator may be in a lower portion of the electrode assembly opposite to the electrode tab. The insulator may include tape that turns into an adhesive based on a reaction with an electrolyte. The buffer may contract and extend in a direction of the electrode tab that extends between a first end of the electrode tab fixed to the electrode assembly and a second end of the electrode tab fixed to a cap plate. The electrode tab may include a bent portion between the first end and the second end and the buffer may be between the first end and the bent portion. The buffer may have a first surface that is concave and a second surface that is convex. The first and second surfaces of the buffer may be round. The first and second surfaces of the buffer may be bent form of a wedge.

The buffer may be a pressed buffer. The buffer may not have overlapping portions in a projecting direction of the electrode tab. The electrode tab may include a first electrode tab and a second electrode tab having different polarities, and the first electrode tab and the second electrode tab respectively may include a plurality of first electrode tabs and a plurality of second electrode tabs.

The secondary battery may include a cap plate to seal the case accommodating the electrode assembly; and an insulating spacer between the electrode assembly and the cap plate. The insulating spacer may include a thin plate or insulating tape including a polymer insulating material. The insulating spacer may include two tab holes into which a plurality of first electrode tabs and a plurality of second electrode tabs are respectively inserted and gathered as a group. The secondary battery may include a cap plate to seal the case accommodating the electrode assembly, wherein the electrode assembly and the cap plate are directly exposed to one another.

### BRIEF DESCRIPTION OF THE DRAWINGS

Features will become apparent to those of skill in the art by describing in detail exemplary embodiments with reference to the attached drawings in which:

FIG. 1 illustrates an embodiment of a secondary battery;

FIGS. 2 and 3 illustrate an embodiment of an insulator;

FIGS. 4 and 5 illustrate an embodiment of a coupling structure of electrode tabs;

FIG. 6A illustrates an embodiment of a buffer of an electrode tab, and FIG. 6B illustrates an embodiment of an electrode tab;

FIG. 7 illustrates a comparative example of an electrode tab;

FIG. 8 illustrates another embodiment of a secondary battery; and

FIG. 9 illustrates another embodiment of a secondary battery.

### DETAILED DESCRIPTION

Example embodiments will now be described with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments (or portions thereof) may be combined to form additional embodiments.

In the drawings, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

When an element is referred to as being “connected” or “coupled” to another element, it can be directly connected or coupled to the another element or be indirectly connected or coupled to the another element with one or more intervening elements interposed therebetween. In addition, when an element is referred to as “including” a component, this indicates that the element may further include another component instead of excluding another component unless there is different disclosure.

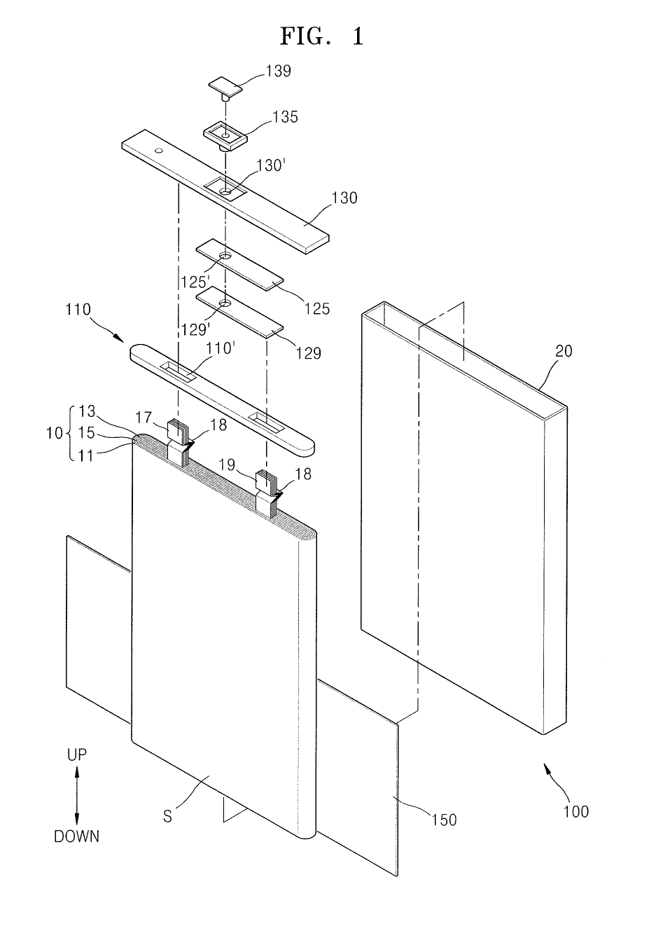

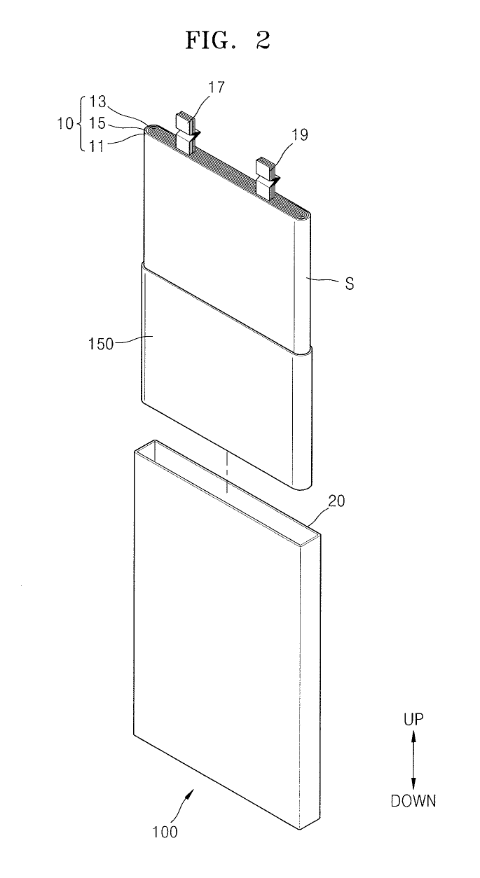

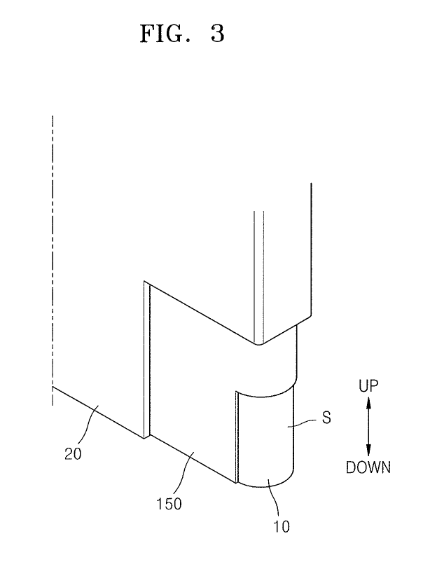

FIG. 1 illustrates an embodiment of a secondary battery 100, and FIGS. 2 and 3 illustrate an embodiment of an insulator 150 in FIG. 1. Referring to FIGS. 1 to 3, the secondary battery 100 may include an electrode assembly 10 from which a first electrode tab 19 and a second electrode tab 17 project, an insulating spacer 110 on the electrode assembly 10, a case 20 accommodating the electrode assembly 10 and the insulating spacer 110, a cap plate 130 sealing an open upper end of the case 20, an electrode terminal 139 exposed outside the cap plate 130, and a terminal plate 129 inside the case 20 and electrically connected to the electrode terminal 139.

The electrode assembly 10 may include a first electrode plate 13, a second electrode plate 11, and a separator 15. For example, the electrode assembly 10 may be formed by winding a stack of the first electrode plate 13, the second electrode plate 11, and the separator 15 in the form of a jelly-roll. The electrode assembly 10 may be accommodated in the case 20 with an electrolyte.

The first electrode tab 19 and the second electrode tab 17 may be connected to at least one portion of the first electrode plate 13 or the second electrode plate 11. For example, the first electrode tab 19 may be connected to the electrode terminal 139 that projects from an upper surface of the cap plate 130. The second electrode tab 17 may be connected directly to the cap plate 130.

The electrode terminal 139 may be coupled in an insulating manner to the cap plate 130 and may protrude on the upper surface of the cap plate 130. For example, an insulating gasket 135 may be between the electrode terminal 139 and the cap plate 130.

An upper end of the case 20 may be open and accommodate the electrode assembly 10 and the electrolyte. The cap plate 130 may be on the open upper end of the case 20. A portion where the cap plate 130 contacts the case 20 may be, for example, welded by a laser to thereby form an air-tight seal.

The terminal plate 129 may be between the first electrode tab 19 and the electrode terminal 139. For example, a first side of the terminal plate 129 may be coupled to the first electrode tab 19. A second side of the terminal plate 129 may include a terminal hole 129′ into which the electrode terminal 139 is inserted. An insulating plate 125 may be between the terminal plate 129 and the cap plate 130, to insulate the terminal plate 129 and the cap plate 130 from each other.

The electrode terminal 139 is inserted into the cap plate 130, with the insulating gasket 135 in between. For example, the electrode terminal 139 may penetrate through respective terminal holes 130′, 125′, and 129′ of the cap plate 130, the insulating plate 125, and the terminal plate 129. In one embodiment, the electrode terminal 139 may sequentially penetrate through the cap plate 130, the insulating plate 125, and the terminal plate 129 in a direction from an upper portion of the cap plate 130 toward a lower portion of the cap plate 130.

The insulating spacer 110 may be between the cap plate 130 and the electrode assembly 10. The insulating spacer 110 may insulate the cap plate 130 and the electrode assembly 10 from each other. The insulating spacer 110 may include a thin plate or an insulating tape including an insulating polymer material. The insulating spacer 110 may include two tab holes 110′ for respectively inserting the first and second electrode tabs 19 and 17 and binding the first and second electrode tabs 19 and 17 as a single pack.

The first electrode tab 19 and the second electrode tab 17 may be respectively inserted into the tab holes 110′ of the insulating spacer 110 and penetrate through an upper portion of the insulating spacer 110 via the tab holes 110′. The first electrode tab 19 penetrating through the insulating spacer 110 may be connected to the electrode terminal 139, that projects on the upper surface of the cap plate 130 via the terminal plate 129. The second electrode tab 17 may be directly connected to the cap plate 130.

The insulator 150 is wrapped around the electrode assembly 10. The insulator 150 may surround the electrode assembly 10 along an outer peripheral surface S of the electrode assembly 10. The insulator 150 may be between the electrode assembly 10 and the case 20 to prevent a short circuit between the electrode assembly 10 and the case 20. For example, the insulator 150 may prevent the electrode assembly 10 from moving. For example, the insulator 150 may react with the electrolyte of the electrode assembly 10 in the case 20 and serve as an adhesive material. The insulator 150 may be between the electrode assembly 10 and the case 20 and fix a relative location of each of the electrode assembly 10 and the case 20, thereby preventing the electrode assembly 10 from moving. For example, the insulator 150 may fix the electrode assembly 10 with respect to the case 20, so that the electrode assembly 10 does not move inside the case 20. Thus, the electrode assembly 10 is not damaged when moved. Since damage to the electrode assembly 10 may directly affect charging and discharging capabilities, it is possible to prevent deterioration of charging and discharging capabilities by preventing damage to the electrode assembly 10.

The insulator 150 may react with the electrolyte and be transformed into an adhesive material. For example, the insulator 150 may react with the electrolyte between the electrode assembly 10 and the case 20, expand in volume, and thus attach to facing surfaces of the electrode assembly 10 and the case 20.

The insulator 150 may also function as a finishing material for preventing the electrode assembly 10 from being loose. For example, the electrode assembly 10 may be formed by winding a stack of the first electrode plate 13 and the second electrode plate 11, in jelly roll form, with the separator 15 therebetween. A first end of the stack may be a start area, and a second end of the stack may be a finish area. The insulator 150 may be attached to the outer peripheral surface S of the electrode assembly 10, which includes the finish area of the stack to prevent the electrode assembly 10 from becoming loose. The outer peripheral surface S of the electrode assembly 10 may correspond, for example, to an outer peripheral surface of the electrode assembly 10 which extends along a winding direction of the electrode assembly 10.

When the insulator 150 is attached along the outer peripheral surface S of the electrode assembly 10, the electrode assembly 10 may be prevented from becoming loose and swelling of the electrode assembly 10 may be prevented. For example, the insulator 150 may prevent the electrode assembly 10 from swelling due to heat generated from charging or discharging. As a result, the resistance of the electrode assembly 10 may be maintained and a reduction in output power may be prevented.

In one embodiment, the insulator 150 may not completely surround the outer peripheral surface S of the electrode assembly 10, but partially surround the outer peripheral surface S of the electrode assembly 10. For example, the insulator 150 may surround only a lower portion of the electrode assembly 10. The insulator 150 may be attached, for example, to a lower portion of the outer peripheral surface S of the electrode assembly 10. However, an upper portion of the electrode assembly 10 may be exposed without the insulator 150 thereon. The insulator 150 may be between the electrode assembly 10 and the case 20 and occupy a space between the electrode assembly 10 and the case 20. A free space in the upper portion of the electrode assembly 10 without the insulator 150 thereon may be utilized to increase energy density, for example, to increase the number of windings of the electrode assembly 10.

The upper portion of the electrode assembly 10 may corresponding, for example, to a side of the electrode assembly 10 from which the first and second electrode tabs 19 and 17 project. The lower portion of the electrode assembly 10 may correspond to a side of the electrode assembly 10 opposite to the first and second electrode tabs 19 and 17.

The insulator 150 may form an adhesive contact between the electrode assembly 10 and the case 20 and thus may prevent movement of the electrode assembly 10. Therefore, even when the insulator 150 is provided at a portion (e.g., the lower portion of the outer peripheral surface S of the electrode assembly 10), movement of the electrode assembly 10 may be sufficiently prevented.

Among the upper and lower portions of the electrode assembly 10, the insulator 150 may be on the lower portion of the electrode assembly 10. For example, the first and second electrode tabs 19 and 17 project from the upper portion of the electrode assembly 10. The electrode assembly 10 may increase in volume due to the first and second electrode tabs 19 and 17 and may swell due to heat generated by charging and discharging accumulated on the first and second electrode tabs 19 and 17. The insulator 150 may be excluded from the upper portion of the electrode assembly 10, so that the increased volume of the electrode assembly 10 may be accommodated. Also, a certain degree of swelling may be allowed without generating excessive internal stress.

According to an embodiment, the insulator 150 is not on the upper portion of the electrode assembly 10. An empty space may exist between the case 20 and the upper portion of the electrode assembly 10. The upper portion of the electrode assembly 10 may not directly contact the case 20. According to another embodiment, a thin plate insulator may be on the upper portion of the electrode assembly 10. The thin plate insulator may insulate the upper portion of the electrode assembly 10 from the case 20. For example, the thin plate insulator on the upper portion of the electrode assembly 10 may be thinner than the insulator 150 on the lower portion of the electrode assembly 10.

For example, the insulator 150 may be provided as tape. As described above, the insulator 150 may include a material that reacts with the electrolyte and becomes adhesive. In one embodiment, the insulator 150 may be a polymer film (tape) that reacts with the electrolyte, partially melts, and thus becomes adhesive. When the polymer film contacts the electrolyte, a carbonate-based solvent (e.g., dimethyl carbonate (DMC), ethyl methyl carbonate (EMC), or propylene carbonate (PC)) in the electrolyte may, for example, penetrate between polymers. As a result, the polymer film may partially melt. An oriented polystyrene (OSP) film may be used, for example, as the insulator 150.

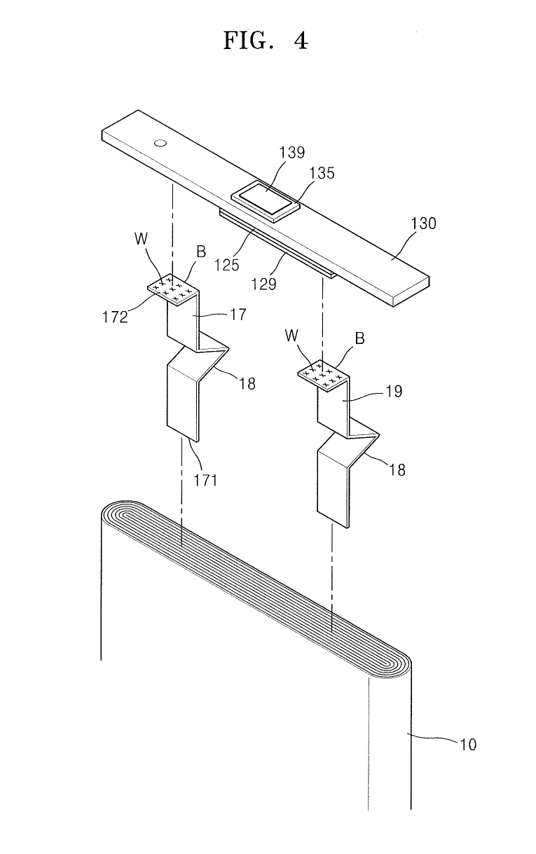

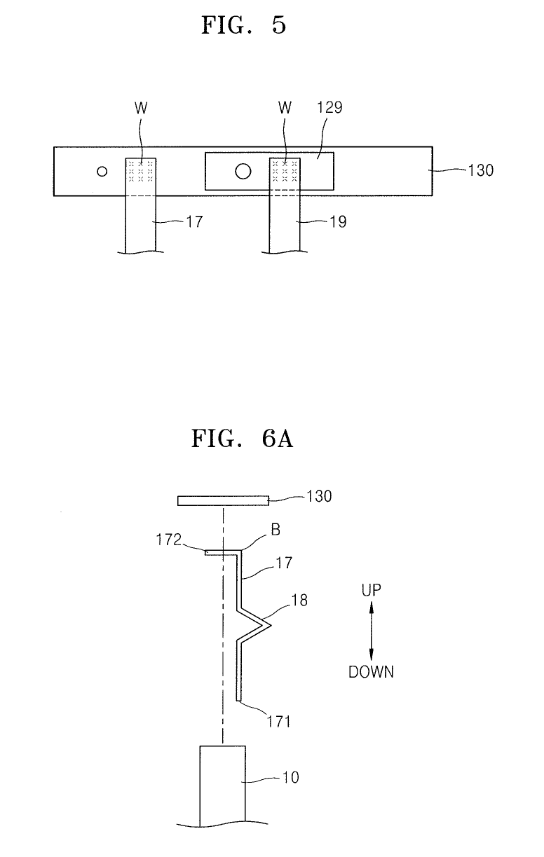

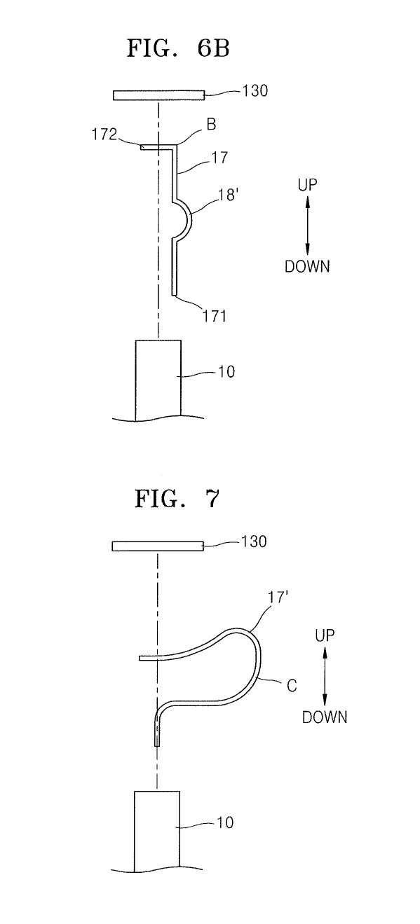

FIGS. 4 and 5 illustrate an embodiment of a coupling structure of electrode tabs in FIG. 1, and FIG. 6A illustrates an embodiment of a buffer of an electrode tab of FIG. 1. The first electrode tab 19 and the second electrode tab 17 may be respectively welded to the terminal plate 129 and the cap plate 130. Each of the first and second electrode tabs 19 and 17 may include, for example, a welding portion W welded to the terminal plate 129 and the cap plate 130. Each of the first and second electrode tabs 19 and 17 has a first end fixed to the electrode assembly 10 and a second end fixed to the terminal plate 129 or the cap plate 130.

In order to weld the first and second electrode tabs 19 and 17, the first and second electrode tabs 19 and 17 may overlap the cap plate 130 to which the terminal plate 129 is coupled. Afterwards, the first and second electrode tabs 19 and 17 may be welded by ultrasonic welding. When the first and second electrode tabs 19 and 17 are welded, as in FIG. 6A, the first and second electrode tabs 19 and 17 are bent such that the cap plate 130 is above the first and second electrode tabs 19 and 17. In FIG. 6A, B represents a bent portion of the second electrode tab 17.

An embodiment of a manufacturing process of a secondary battery will be described with reference to FIGS. 4 and 5. The second electrode tab 17 may be welded to the cap plate 130 when the cap plate 130 and the electrode assembly 10 are laid flat and the second electrode tab 17 overlaps the cap plate 130. The first electrode tab 19 has a polarity opposite to the second electrode tab 17 and may be welded to the terminal plate 129 connected to the electrode terminal 139. For example, the first electrode tab 19 may overlap the terminal plate 129 coupled to the cap plate 130, and the terminal plate 129 and the first electrode tab 19 may be welded together.

When the first and second electrode tabs 19 and 17 are welded, the cap plate 130 may be bent over the electrode assembly 10. Then, the first and second electrode tabs 19 and 17 may also be bent, thereby forming upper portions that extend from a lower portion connected to the electrode assembly 10 to the cap plate 130.

Next, the insulator 150 may be attached along the outer peripheral surface S of the electrode assembly 10. The electrode assembly 10 and the electrolyte may then be accommodated in the case 20. Then an area, between the cap plate 130 connected to the electrode assembly 10 and the case 20, are sealed. The electrode assembly 10 in the case 20 may be sealed, for example, by welding along peripheries of the cap plate 130 and the case 20.

One of the first or second electrode tabs 19 and 17, for example, the second electrode tab 17, will be mainly described. Technical features of the second electrode tab 17 may also be applied to the first electrode tab 19 in substantially the same manner.

Referring to FIG. 6A, a buffer 18 may be on the second electrode tab 17. The buffer 18 may reduce tension in the second electrode tab 17 and absorb shock in a lengthwise direction between a first end 171 fixed to the electrode assembly 10 and a second end 172 fixed to the cap plate 130. In the second electrode tab 17, the buffer 18 may be between the first end 171 and the second end 172. For example, a bent portion B may be between the first and second ends 171 and 172 of the second electrode tab 17, and the buffer 18 may be formed between the first end 171 and the bent portion B.

For example, tension may be applied to the second electrode tab 17 due to subtle movement of the electrode assembly 10. External force may be applied to the first end 171 or the second end 172 of the second electrode tab 17. Thus, the second electrode tab 17 may be disconnected. The buffer 18 may allow contraction or extension with respect to a length of the second electrode tab 17 between the first and second ends 171 and 172 of the second electrode tab 17, in order to prevent the second electrode tab 17 from being disconnected between the first and second ends 171 and 172 of second electrode tab 17.

The buffer 18 of the second electrode tab 17 may be formed, for example, by pressing, e.g., arranging a raw material between an upper die and a lower die facing each other, pressing the upper die and the lower die toward each other, and transferring respective shapes of the upper and lower dies onto the raw material.

The buffer 18 of the second electrode tab 17 may have a concave surface and a convex surface on each side. According to another embodiment, the buffer 18 may have a concave surface and a flat surface on each side. Although the buffer 18 may be regarded as a groove, a surface opposite to a concave surface may be convex or flat. According to an embodiment, the buffer 18 may be formed in a wedge shape that is bent and has a concave surface and a convex surface. For example, both surfaces of the buffer 18 may be formed as a wedge. When the buffer 18 is more flexible than other portions of the second electrode tab 17, and thus allows extension and contraction of the second electrode tab 17, the buffer 18 may have a shape different from a wedge or bent shape.

FIG. 6B illustrates an embodiment of an electrode tab. In this embodiment, a buffer 18′ may have a concave surface and a convex surface. The surfaces of the buffer 18′ may, for example, be round. The buffer 18′ may allow contraction and extension of a portion of the second electrode tab 17 between the first end 171 fixed to the electrode assembly 10 and the second end 172 fixed to the cap plate 130, and may absorb tension applied to the second electrode tab 17.

FIG. 7 illustrates a comparative example of an electrode tab 17′ which projects from the upper portion of the electrode assembly 10. In this case, a bypass unit C may be on the electrode tab 17′. For example, when a first end of the electrode tab 17′ is connected to the electrode assembly 10 and a second end of the electrode tab 17′ is connected to the cap plate 130, the bypass unit C may extend between the first and second ends of the electrode tab 17′ and absorb shock between the first and second ends of the electrode tab 17′.

When the bypass unit C absorbs shock between the first and second ends of the electrode tab 17′, a sufficient length may be maintained between the first and second ends of the electrode assembly 10, and tension is not applied to the first end fixed to the electrode assembly 10 and the second end fixed to the cap plate 130 due to movement of the electrode assembly 10. The bypass unit C may be between the first and second ends of the electrode tab 17′ and contract/extend the length between the first and second ends of the electrode tab 17′. The bypass unit C may be formed by not extending a portion between the first and second ends of the electrode tab 17′ in a straight line according to a shortest path, but by bending the portion according to a circumventing path.

When inserting the electrode tab 17′ with extra portions into the upper portion of the electrode assembly 10, the bypass unit C may have overlapping portions. In this case, with regard to a vertical direction, the direction in which the electrode tab 17′ projects from the electrode assembly 10 may be regarded as an upper direction and the opposite direction may be regarded as a lower direction.

The insulator 150 may be prepared to prevent movement of the electrode assembly 10. Therefore, the second electrode tab 17 that projects from the electrode assembly 10 may not include a bypass unit. For example, since the electrode assembly 10 is fixed to the case 20 because of the insulator 150, that is attached along the outer peripheral surface S of the electrode assembly 10, movement of the electrode assembly 10 is restrained. Accordingly, the second electrode tab 17 does not require a bypass unit.

Since the bypass unit is not in the second electrode tab 17, the length of the second electrode tab 17 may be reduced, material costs may be saved, and an upper space of the electrode assembly 10 for accommodating the bypass unit C may be omitted. According to the comparative example of FIG. 7, the upper space of the electrode assembly 10 is required to accommodate the bypass unit C of the electrode tab 17′. However, according to an embodiment, the upper space of the electrode assembly 10 may be omitted. Therefore, a vertical length of the electrode assembly 10 may be increased, which leads to greater electric power with respect to an identical external size and increased energy density of the secondary battery.

The buffer 18 according to an embodiment is different from the bypass unit C according to the comparative example of FIG. 7. Although the buffer 18 does not have overlapping portions in the vertical direction, the bypass unit C of the comparative example has overlapping portions in the vertical direction. For example, the buffer 18 may be formed by pressing, that includes arranging a raw material between an upper die and a lower die facing each other, pressing the upper die and the lower die toward each other, and transferring respective shapes of the upper and lower dies onto the raw material. As a result, the buffer 18 may not include overlapping portions.

The buffer 18 of the second electrode tab 17 does not include overlapping portions in the vertical direction, and thus does not occupy a large area of the upper space of the electrode assembly 10. However, the bypass unit C of the electrode tab 17′ according to the comparative example of FIG. 7 includes overlapping portions in the vertical direction, and thus occupies a large area of the upper space of the electrode assembly 10. Due to spatial limitations caused by the bypass unit C, it may be difficult to provide a secondary battery with high energy density. Even though the bypass unit C of FIG. 7 may be effective for contracting and extending the length of the electrode tab 17′, according to an embodiment, the insulator 150 may restrain movement of the electrode assembly 10. As a result, the buffer 18 of the second electrode tab 17 may provide sufficient shock absorbing properties.

An insulating unit may be formed on the buffer 18 of the second electrode tab 17. The buffer 18 may be convex toward a direction different from a projecting direction of the second electrode tab 17. Therefore, the insulating unit may be on the buffer 18 of the second electrode tab 17 to prevent a short circuit between different polarities of the electrode assembly 10.

As shown in FIG. 1, each of the first and second electrode tabs 19 and 17 may be include a plurality of first electrode tabs and a plurality of second electrode tabs. A plurality of first electrode tabs 19 and a plurality of second electrode tabs 17 respectively indicate a plurality of first electrode tabs 19 having a first polarity and a plurality of second electrode tab 17 having a second polarity opposite to the first polarity. One embodiment may include a plurality of first electrode tabs 19 with identical polarity and a plurality of second electrode tabs 17 with identical polarity.

The plurality of first and second electrode tabs 19 and 17 may penetrate through the tab holes 110′ in the insulating spacer 110 and thus be gathered as a group of first second electrode tabs 19 and a group of second electrode tabs 17. The respective groups of first and second electrode tabs 19 and 17 may be welded to the terminal plate 129 or the cap plate 130.

The insulating spacer 110 may be between the cap plate 130 and the electrode assembly 10 to prevent a short circuit between the cap plate 130 and the electrode assembly 10. Also, the insulating spacer 110 may include the tab holes 110′ through which the pluralities of first and second electrode tabs 19 and 17 penetrate. The pluralities of first and second electrode tabs 19 and 17 may be gathered into respective groups of the first and second electrode tabs 19 and 17.

The insulating spacer 110 may be as a thin plate including a polymer insulating material such as plastic. The insulating spacer 110 is between the cap plate 130 and the electrode assembly 10 to prevent a short circuit therebetween. According to an embodiment, since the cap plate 130 is fixed to the upper end of the case 20 while the location of the electrode assembly 10 is fixed with respect to the case 20 by the insulator 150, respective locations of the electrode assembly 10 and the cap plate 130 may be fixed with respect to the case 20. Thus, a distance may be formed between the electrode assembly 10 and cap plate 130. In one embodiment, the insulating spacer 110 may be a simple thin plate including an insulating material. Even when the structure of the insulating spacer 110 is simplified, insulating properties may be adequately maintained.

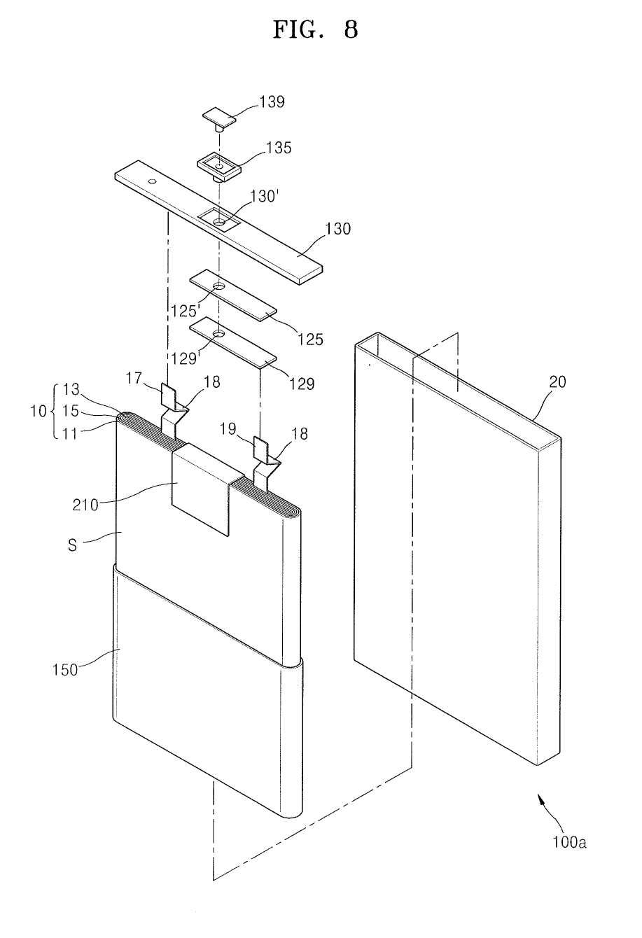

FIG. 8 illustrates another embodiment of a secondary battery 100a which may include an electrode assembly 10 from which a first electrode tab 19 and a second electrode tab 17 project, an insulating spacer 210 attached on the electrode assembly 10, a case 20 accommodating the electrode assembly 10 and the insulating spacer 210, a cap plate 130 sealing an open upper end of the case 20, an electrode terminal 139 exposed outside the cap plate 130, and a terminal plate 129 inside the case 20 and electrically connected to the electrode terminal 139.

The insulating spacer 210 may be, for example, insulating tape attached on the electrode assembly 10. In one embodiment, the insulating spacer 210 may be between the terminal plate 129 and the electrode assembly 10 and attached to surround an upper portion of the electrode assembly 10 between first and second electrode tabs 19 and 17.

The insulating spacer 210 is between the cap plate 130 and the electrode assembly 10 to prevent a short circuit therebetween. According to an embodiment, since the cap plate 130 is fixed to the upper end of the case 20, while the location of the electrode assembly 10 is fixed with respect to the case 20 by an insulator 150, respective locations of the electrode assembly 10 and the cap plate 130 may be fixed with respect to the case 20. Thus, a distance may be formed between the electrode assembly 10 and cap plate 130. The insulating spacer 210 may be, for example, a simple thin plate including an insulating material. Even when a structure of the insulating spacer 210 is simplified, insulating properties may be adequately maintained.

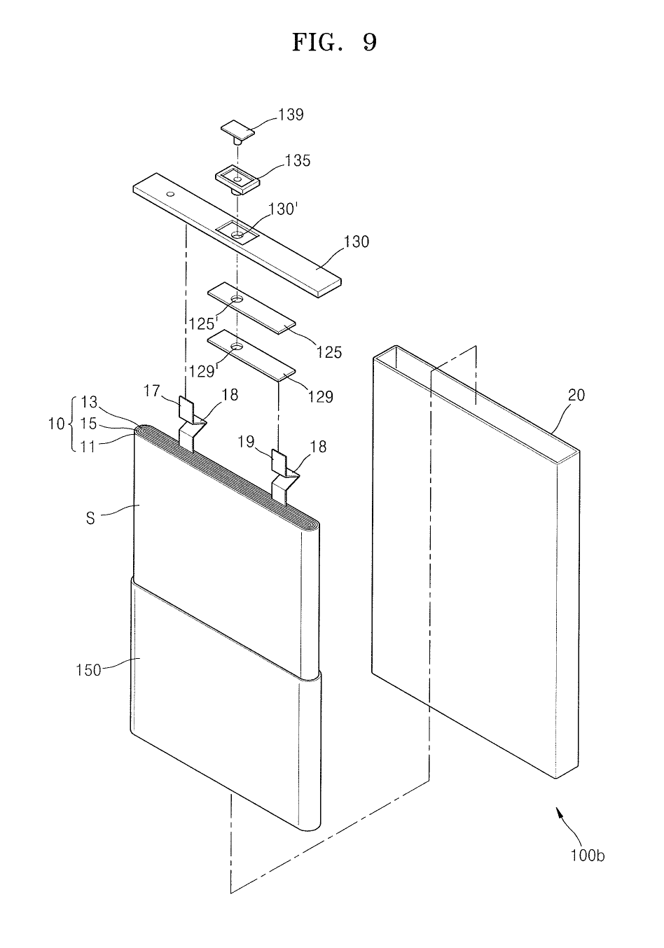

FIG. 9 illustrates another embodiment of a secondary battery 100b which may include an electrode assembly 10 from which a first electrode tab 19 and a second electrode tab 17 project, a case 20 accommodating the electrode assembly 10, a cap plate 130 sealing an open upper end of the case 20, an electrode terminal 139 exposed outside the cap plate 130, and a terminal plate 129 inside the case 20 and electrically connected to the electrode terminal 139.

According to the present embodiment, the electrode assembly 10 and the cap plate 130 may be directly exposed to one another, which indicates that the electrode assembly 10 and the cap plate 130 are directly facing one another without another component between the electrode assembly 10 and the cap plate 130. Thus, according to the present embodiment, an insulating spacer is not between the electrode assembly 10 and the cap plate 130, e.g., the insulating spacer may be omitted.

According to an embodiment, since the cap plate 130 is fixed to an upper end of the case 20 while the location of the electrode assembly 10 is fixed with respect to the case 20 by an insulator 150, respective locations of the electrode assembly 10 and the cap plate 130 may be fixed with respect to the case 20. Thus, a distance may be formed between the electrode assembly 10 and cap plate 130. In one embodiment, the insulating spacer may be omitted between the cap plate 130 and the electrode assembly 10.

In accordance with one or more of the aforementioned embodiments, a secondary battery includes an insulator that surrounds an electrode assembly which is capable of firmly fixing the location of an electrode assembly and restraining movement of the electrode assembly. As a result, the structure of the secondary battery is simplified. For example, by preventing the electrode assembly from moving, the structure of an electrode tab or internal components such as an insulating spacer may be simplified to manage movement of the electrode assembly.

Also, a buffer may be provided on an electrode tab that forms a current path of the electrode assembly. As a result, the electrode tab may not be damaged due to applied tension, when the electrode assembly is moved, to the electrode tab having fixed ends.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise indicated. Accordingly, various changes in form and details may be made without departing from the spirit and scope of the embodiments set forth in the claims.

What is claimed is:

1. A secondary battery, comprising:
an electrode assembly including an electrode tab with a buffer;
a case to accommodate the electrode assembly; and
an insulator between the electrode assembly and the case.

2. The secondary battery as claimed in claim 1, wherein the insulator is attached to an outer peripheral surface of the electrode assembly.

3. The secondary battery as claimed in claim 1, wherein:
the insulator is attached to a surface of the electrode assembly and a surface of the case, and
the surfaces of the electrode assembly and the case face each other.

4. The secondary battery as claimed in claim 1, wherein the insulator is in a lower portion of the electrode assembly opposite to the electrode tab.

5. The secondary battery as claimed in claim 1, wherein the insulator includes tape that turns into an adhesive based on a reaction with an electrolyte.

6. The secondary battery as claimed in claim 1, wherein the buffer contracts and extends in a direction of the electrode tab that extends between a first end of the electrode tab fixed to the electrode assembly and a second end of the electrode tab fixed to a cap plate.

7. The secondary battery as claimed in claim 6, wherein:
the electrode tab includes a bent portion between the first end and the second end, and
the buffer is between the first end and the bent portion.

8. The secondary battery as claimed in claim 1, wherein the buffer has a first surface that is concave and a second surface that is convex.

9. The secondary battery as claimed in claim 8, wherein the first and second surfaces of the buffer are round.

10. The secondary battery as claimed in claim 8, wherein the first and second surfaces of the buffer are bent form of a wedge.

11. The secondary battery as claimed in claim 1, wherein the buffer is a pressed buffer.

12. The secondary battery as claimed in claim 11, wherein the buffer does not have overlapping portions in a projecting direction of the electrode tab.

13. The secondary battery as claimed in claim 1, wherein:
the electrode tab includes a first electrode tab and a second electrode tab having different polarities, and
the first electrode tab and the second electrode tab respectively include a plurality of first electrode tabs and a plurality of second electrode tabs.

14. The secondary battery as claimed in claim 1, further comprising:
a cap plate to seal the case accommodating the electrode assembly; and
an insulating spacer between the electrode assembly and the cap plate.

15. The secondary battery as claimed in claim 14, wherein the insulating spacer includes a thin plate or insulating tape including a polymer insulating material.

16. The secondary battery as claimed in claim 14, wherein the insulating spacer includes two tab holes into which a plurality of first electrode tabs and a plurality of second electrode tabs are respectively inserted and gathered as a group.

17. The secondary battery as claimed in claim 1, further comprising:
a cap plate to seal the case accommodating the electrode assembly,
wherein the electrode assembly and the cap plate are directly exposed to one another.
